(19) United States
(12) Patent Application Publication
(10) Pub. No.: US 2013/0169189 A1
(43) Pub. Date: Jul. 4, 2013

(54) Variable Operating Mode Solar Lighting System

(71) Applicant: Bruce Bernard, North Vancouver (CA)

(72) Inventor: Bruce Bernard, North Vancouver (CA)

(73) Assignee: Carmanah Technologies Corp., Victoria, BC (CA)

(21) Appl. No.: 13/810,196

(22) PCT Filed: Sep. 21, 2010
(86) PCT No.: PCT/CA2010/001505

§ 371 Date: Mar. 18, 2013

(30) Foreign Application Priority Data
Jul. 14, 2010 (CA) 2,709,745

(51) Int. Cl. H05B 37/02

(52) U.S. Cl. CPC H05B 37/02
USPC 315/307

(57) ABSTRACT

A solar lighting system includes a record of a plurality of lighting profiles. The particular profile that governs the operation of the lights of the system at any given time is selected by each lighting element according to its determination of the time of year or season. The invention allows the more efficient use of solar energy collected at various time of the year.

### FIELD OF THE INVENTION

This invention relates to solar-powered lighting systems. In particular, this invention relates to selectable lighting profiles for solar-powered lighting systems.

### BACKGROUND OF THE INVENTION

Solar-powered lighting systems are increasingly used to illuminate locations that are inaccessible from the wired power grid or simply because a renewable source of energy is preferred. Solar-powered lighting systems are typically configured to operate according to a specific lighting profile. The profiles include parameters such as system activation time (for example based on real time, or based on the onset of dusk or of dawn), flash duty cycle, flash patterns, brightness and reaction to motion sensors and other local events. For example, a marine buoy navigation beacon may be provided with a particular flash pattern that activates only between dusk and dawn. A city park may choose to provide constant light beginning at dusk for a period of 5 hours then dim for the remainder of the night when fewer visitors are expected. A parking lot lighting system may become active at dusk but dim after midnight and only provide bright light for a predetermined period of time after a motion sensor detects movement in the parking lot.

The particular profiles that are made available for a given customer's application depend on a worst case scenario, having regard to the insolation that will be available at the destination latitude and location, during the shortest day of the year. This ensures that the solar panel and its associated energy storage system will be able to collect and deliver sufficient energy to operate according to those profiles year round. The drawback to that approach is that the extra energy that becomes available during the summer months is wasted. Lights which during winter may only be able to run a few hours after dusk before being dimmed down, may well have been able to run all night and at full brightness during the summer. This would suit certain applications. For example, recreation areas should have more relative light in the summer when the area is heavily used than in the winter when they are lightly used or is closed.

It is therefore an object of this invention to provide a solar-powered lighting system that avoids the wasted energy from being configured using worst case of the year scenario for insolation.

It is another object of the invention to provide greater flexibility in the lighting profiles made available to a particular customer.

These and other objects of the invention will be better understood by reference to the detailed description of the preferred embodiment which follows. Note that not all of the objects are necessarily met by all embodiments of the invention described below or by the invention defined by each of the claims.

### SUMMARY OF THE INVENTION

According to the invention, a solar-powered lighting system is made configurable with a plurality of lighting profiles, with particular ones of the profiles being activated as a function of the time of year. The current time of year may be determined by detection of solar events, or it may be communicated to the lighting system by an external source. This enables the use of a more ambitious profile during the summer and a more conservative profile during the winter for the same customer system.

In one aspect, the invention comprises a lighting system comprising a plurality of lighting elements, each of which comprises a light source, a solar panel, memory and a processor, characterized in that the memory has recorded therein a plurality of lighting profiles, each of the profiles comprising a set of parameters of operation for said light source; and the processor being configured to control the light source according to a particular profile. The parameters of operation may be selected from the group of parameters comprising turn on time, turn off time, turn on event, turn off event, brightness, period of on-time, period when the light source will be reactive to a sensor event.

In a further aspect, the processor may be configured to select among the profiles in response to an event from among the group of events comprising determination of a particular time of year, detection of the occurrence of equinox, and receipt of a signal from a source external to said lighting element. The lighting element may comprise a clock and the determination of the time of year may be by reference to the clock. The lighting element may comprise a GPS unit and the determination of the time of year may be by reference to a signal received by said GPS unit. Detection of the occurrence of equinox may be by a comparison of the duration of daylight and the duration of night over a predetermined period of time. The duration of daylight and the duration of night may be determined by the level of insolation of said solar panel.

In another aspect, the invention comprises a method of operating a lighting system comprising a plurality of lighting elements, each lighting element comprising a light source, a solar panel, memory and a processor adapted to control the operation of the light source, the method characterized by recording in the memory of each of the lighting elements at least two lighting profiles, each of the lighting profiles comprising a set of parameters for the operation of the light source, the parameters being selected from among the group of parameters comprising turn on time, turn off time, turn on event, turn off event, brightness, period of on-time, period when the light source will be reactive to a sensor event; determining the occurrence of a triggering event selected from among the group of events comprising the occurrence of a particular time of year, the occurrence of equinox, receipt of a transition signal from an external source; and, upon determining the occurrence of the triggering event, controlling the operation of the light source according to a different one of the lighting profiles than before the triggering event.

The foregoing was intended as a broad summary only and of only some of the aspects of the invention. It was not intended to define the limits or requirements of the invention. Other aspects of the invention will be appreciated by reference to the detailed description of the preferred embodiment and to the claims.

### BRIEF DESCRIPTION OF THE DRAWINGS

The invention will be described by reference to the detailed description of the preferred embodiment and to the drawings thereof in which:

FIG. 1 is a diagram of a lighting system according to the preferred embodiment; and

FIG. 2 is a block diagram of a controller lighting element used in the preferred embodiment.

### DETAILED DESCRIPTION OF THE PREFERRED EMBODIMENT

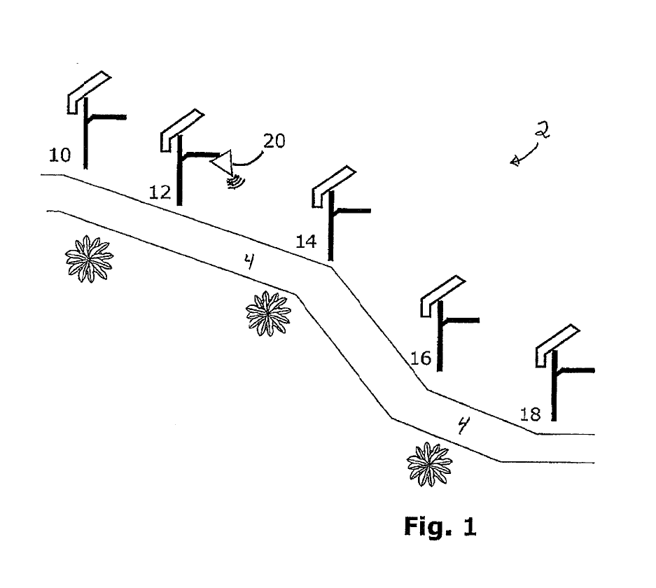

FIG. 1 is a diagram of a lighting system 2 used to illuminate a pathway 4 according to the preferred embodiment of the invention. In the exemplary embodiment, pathway 4 is in a public park.

Lighting system 2 includes a plurality of lighting elements 10, 12, 14, 16 and 18, with element 10 acting as a controller for the other lighting elements. Controller 10 coordinates a variety of operational features of the lighting system 2 such as wireless communications between the lighting elements, system diagnostics and synchronization of operational parameters. A motion sensor 20 is associated with lighting element 12.

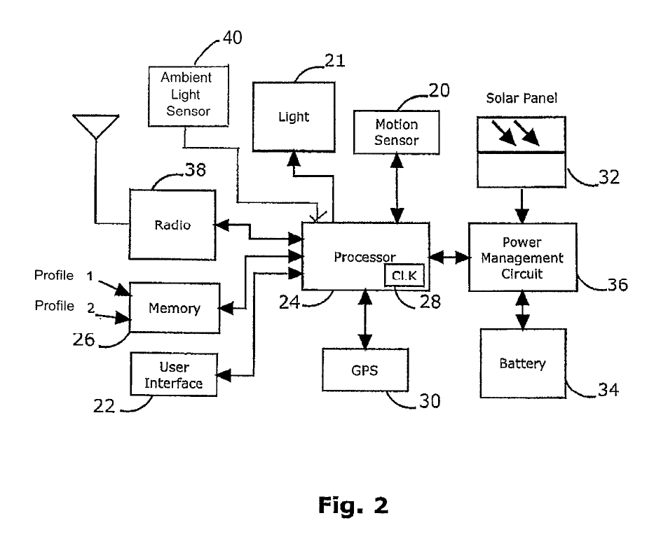

Referring to FIG. 2, lighting element 12 includes a motion sensor 20 (the EW Low Voltage Outdoor Motion Sensor from WattStopper is an example of a suitable sensor for this application), an LED light 21 and its associated LED driver (e.g. Linear Technology® LT3755), a user interface 22 (which may be a push button with LED display interface), a processor 24 (such as Texas Instruments® MSP430-5438) including a clock 28, memory 26 (which may be flash memory such as Atmel® No. AT25DF041A or an EEPROM such as Atmel® No. AT24C1024B), a GPS unit 30 (e.g. Delorme® GM-20581D-00), a solar panel 32, a 12V or 24V battery 34, a power management circuit 36, a radio 38 (such as Digi™ 2.4 GHz Mesh Radio XBP24 DMUIY-250), and an ambient light sensor 40 (which may be a LCP-12D from Precision Multiple Controls Inc.).

Controller 10 may comprise similar components to lighting element 12 save for the motion sensor 20. It will be appreciated that motion sensors may be provided at only strategic locations along the pathway 4, or could be associated with every one of the lighting elements of the lighting system.

Memory 26 contains records of at least two profiles for the operation of the lighting elements 10-18. Each profile is a set of one or more of the following parameters: turn on time, turn off time, turn on event, turn off event, brightness, period of on-time and period when the light will be reactive to a sensor event.

Combinations of such parameters are used to construct a given profile. For example, a “Programmed Run” profile provides that the lights will turn on at dusk and will stay on for a predetermined period of time, for example 4 hours. A profile known as “Split Night with Dimming” provides that the lights will turn on at dusk for a few hours, then dim down for most of the night, then regain full brightness a short time before dawn is predicted to occur. Yet another profile is a variant of Split Night with Dimming, wherein the lights will also turn on to full brightness for a predetermined short period of time if a motion sensor detects movement during what would otherwise be designated as a dim light period.

An example of a set of profiles, in this case a “summer profile” and a “winter profile”, that is recorded in memory 26 for a given installation is as follows:

Summer Profile (Profile 1)
Lights on (full brightness) beginning at dusk for a period of 4 hours;
From dusk+4 hours to dusk+7 hours, lights dim to 25% but change to full brightness for 3 minutes in reaction to the detection of motion;
From dusk+7 hours until dawn, lights to full brightness;
Lights off at dawn.

Winter Profile (Profile 2)
Lights on (full brightness) beginning at dusk for a period of 3 hours;
from dusk+3 hours to dusk+9 hours, lights off;

In operation, controller 10 may operate to detect the onsets of dusk and dawn by tracking the level of insolation received on its solar panel 32 or using a dedicated ambient light sensor 40. Processor 24 reacts to the detection of dusk by causing memory 26 to keep a record of the time of onset of dusk and of dawn over successive days.

The conditions under which a change between the two profiles is made may also be characterized by a set of parameters. In the preferred embodiment, the toggling between the two profiles is determined using feedback from ambient light sensors used to determine the duration of daylight, preferably over successive days. Thresholds for the duration of daylight are pre-determined to be indicative of summer or winter for a given location. To increase reliability, daylight duration readings over successive days are used. In the preferred embodiment, if three successive summer thresholds of daylight duration are reached over consecutive days, this is treated as the onset of summer. Three successive winter thresholds of night hours are treated as the onset of winter.

The change from one profile to another can also be triggered on a variety of other bases. In one embodiment, the GPS unit 30, or a real time clock, may be used to determine the current date. When that date coincides with a pre-determined date retained programmed into memory 26, for example October 6 (about 2 weeks after the fall equinox), a change to the winter profile may be implemented by processor 24. In an alternative embodiment, the changeover is based on a comparison of the lengths of the day and night and a switchover is implemented when the day and night lengths are equal, i.e. at equinox. In yet another embodiment, the transition between profiles may be triggered by receipt at radio 38 of a transition signal from an external source.

Once the given profile to be used is determined, processor 24 operates to trigger light 21 according to that profile. This may include taking into account motion events such as the detection of motion (or cessation of detection of motion) from motion sensor 20, the communication of the profile to other lighting elements by means of radio 38, user inputs from user interface 22 and/or general power management control as may be determined by the output of power management circuit 36, and sending appropriate control signals to light 21 to operate it according to the determined profile recorded in memory 26.

It will also be appreciated that more than two profiles may be used to enhance the configurability of the lighting system and to ensure optimal use of the collected power.

The invention therefore provides the ability to take full advantage of the power collected from the solar panels at all times of the year, while providing enhanced configurability of the system to accommodate user needs for different seasonal, usage or other lighting conditions.

It will be appreciated by those skilled in the art that the preferred and alternative embodiments have been described in some detail but that certain modifications may be practiced without departing from the principles of the invention.

1. A lighting system comprising a plurality of lighting elements, each of said lighting elements comprising a light source, a solar panel, memory and a processor, characterized in that:
said memory has recorded therein a plurality of lighting profiles, each of said profiles comprising a set of parameters of operation for said light source;
said processor is configured to control said light source according to a particular one of said profiles.

2. The system of claim 1 wherein said parameters of operation are selected from the group of parameters comprising:
turn on time, turn off time, turn on event, turn off event, brightness, period of on-time, period when the light source will be reactive to a sensor event.

3. The system of claim 2 wherein said processor is configured to select among said profiles in response to an event from among the group of events comprising:
determination of a particular time of year, detection of the occurrence of equinox, receipt of a signal from a source external to said lighting element.

4. The system of claim 3 wherein said lighting element further comprises a clock and said determination of the time of year is by reference to said clock.

5. The system of claim 3 wherein said lighting element further comprises a GPS unit and said determination of the time of year is by reference to a signal received by said GPS unit.

6. The system of claim 3 wherein the detection of the occurrence of equinox is by a comparison of the duration of daylight and the duration of night over a predetermined period of time.

7. The system of claim 6 wherein the duration of daylight and the duration of night are determined by the level of insolation of said solar panel.

8. A method of operating a lighting system comprising a plurality of lighting elements, each of said lighting elements comprising a light source, a solar panel, memory and a processor adapted to control the operation of said light source, the method characterized by:
recording in said memory of each of said lighting elements at least two lighting profiles, each of said lighting profiles comprising a set of parameters for the operation of said light source, said parameters being selected from among the group of parameters comprising turn on time, turn off time, turn on event, turn off event, brightness, period of on-time, period when the light source will be reactive to a sensor event;
determining the occurrence of a triggering event selected from among the group of events comprising the occurrence of a particular time of year, the occurrence of equinox, receipt of a transition signal from an external source; and,
upon determining the occurrence of said triggering event, controlling the operation of said light source according to a different one of said lighting profiles than before said triggering event.
